(19) United States
(12) Patent Application Publication
(10) Pub. No.: US 2006/0075923 A1
(43) Pub. Date: Apr. 13, 2006

(54) Method of manufacture and treatment of wood with injectable particulate iron oxide

(76) Inventor: H. Wayne Richardson, Sumter, SC (US)

Correspondence Address: MORGAN LEWIS & BOCKIUS LLP, 1111 PENNSYLVANIA AVENUE NW, WASHINGTON, DC, 20004, US

(21) Appl. No.: 10/961,143

(22) Filed: Oct. 12, 2004

(51) Int. Cl. C09D 5/14; C09D 5/16; B05D 1/12; B05D 3/02

(52) U.S. Cl. 106/18.26; 427/393; 427/440; 427/180; 106/15.05

(57) ABSTRACT

A wood preservative includes injectable particles comprising one or more sparingly soluble iron salts. The iron-based particles are sufficiently insoluble so as to not be easily removed by leaching but are sufficiently soluble to exhibit toxicity to primary organisms primarily responsible for the decay of the wood. Wood or a wood product may be impregnated with iron-based particles of the invention.

### CROSS-REFERENCE TO RELATED APPLICATIONS

N/A.

### STATEMENT REGARDING FEDERALLY SPONSORED RESEARCH OR DEVELOPMENT: N/A

### INCORPORATION-BY-REFERENCE OF MATERIAL SUBMITTED ON A COMPACT Disc

N/A.

### SEQUENCE LISTING

N/A.

### FIELD OF THE INVENTION

The present invention relates to wood preservatives, particularly wood preservatives comprising particles including one or more iron compounds. More particularly, the invention relates to a wood preservative comprising injectable particles of sparingly soluble iron salts, as well as methods to prepare the wood preservative, and methods of preserving wood using the wood

### BACKGROUND OF THE INVENTION

Preservatives are used to treat wood to resist insect attack and decay. However, wood treated with such preservatives often has undesirable color and/or appearance and is prone to weathering to a gray colored material. The commercially used preservatives are separated into the following three basic categories, based primarily on the mode of application: waterborne, creosote, and oil borne preservatives. Waterborne preservatives include chromated copper arsenate (CCA), alkanolamine copper with an organic biocide, and ammoniacal copper quaternary. Wood treated with these chemicals sometimes turn green or grey-green because of a chemical reaction between copper in the preservative and the sun's ultraviolet rays. The preservatives leach into the soil over time when exposed to weather. Creosote does not easily leach into soil, and it is not corrosive to metals, but it can not be painted and it leaves a dark, oily surface that has a strong odor. Oil borne preservatives are made of certain compounds dissolved in light petroleum oils, including pentachlorophenol (commonly known as “penta”), copper naphthenate, and copper-8-quinolinolate. These preservatives leave a surface that often is non-paintable, dark, and unnaturally colored.

Modern organic biocides are considered to be relatively environmentally benign and are not expected to pose the problems associated with CCA-treated lumber. Biocides such as tebuconazole are quite soluble in common organic solvents, while others such as chlorothalonil possess only low solubility. The solubility of organic biocides affects the markets for which the biocide-treated wood products are appropriate. Biocides with good solubility can be dissolved at high concentrations in a small amount of organic solvents, and that solution can be dispersed in water with appropriate emulsifiers to produce an aqueous emulsion. The emulsion can be used in conventional pressure treatments for lumber, and wood treated in such a manner can be used in products such as decking, where the treated wood will come into contact with humans. Biocides which possess low solubility are incorporated into wood in a solution of a hydrocarbon oil, such as AWPA P9 Type A, and the resulting organic solution used to treat wood directly. Wood treated in this way can be used only for industrial applications, such as utility poles and railway ties, because the oil is irritating to human skin. It is therefore desirable to obtain another method of treating wood with these low-solubility organic biocides.

The primary preserved wood product has historically been southern pine lumber treated with chromated copper arsenate (CCA). A new generation of copper-containing wood preservatives uses a form of copper that is soluble, such as copper alkanolamine complexes, copper polyaspartic acid complex, alkaline copper quaternary, copper azole, copper boron azole, copper bis(dimethyldithiocarbamate), ammoniacal copper citrate, copper citrate, and copper ethanolamine carbonate. In practice, the principal criteria for commercial acceptance, assuming treatment efficacy, is cost. Of the many compositions listed above, only two soluble copper containing wood preservatives have found commercial acceptance: 1) the copper ethanolamine carbonate manufactured, for example, according to the process disclosed in U.S. Pat. No. 6,646,147; and 2) copper boron azole. There are, however, several problems with these new copper-containing preservatives.

The soluble copper-containing wood preservatives are very leachable, compared to CCA. One study has shown that as much as 80 percent of the copper from a copper amine carbonate complex is removed in about 10 years under a given set of field conditions. Under severe conditions such as the those used for the American Wood Preserving Association's standard leaching test, these products are quickly leached from the wood. For example, we found that 77% by weight of a Cu-monoethanolamine preservative was leached from the preserved wood in 14 days. This leaching is of concern for at least two reasons: 1) removal of the copper portion of the pesticide from the wood by leaching will compromise the long term efficacy of the formulation, and 2) the leached copper causes concern that the environment will be contaminated. While copper in low concentrations is not harmful to most animals, copper is extremely toxic to certain fish at sub-part per million levels. A common EC₅₀ range for copper is between 2 and 12 micrograms per liter. In a study which reported following the Synthetic Precipitation Leaching Procedure, the leachate from CCA-treated wood contained about 4 mg copper per liter; leachate from copper boron azole-treated wood contained about 28 mg copper per liter; leachate from copper bis(dimethyldithiocarbamate) treated wood contained 7 to 8 mg copper per liter; leachate from alkaline copper quaternary treated wood contained 29 mg copper per liter; and leachate from copper citrate treated wood contained 62 mg copper per liter. CCA comprised about 7% of total copper leach, the alkaline copper quaternary preservative comprised about 12% of the total copper leach, while the copper boron azole comprised about 22% of the total copper leach during the Synthetic Precipitation Leaching Procedure. Copper leaching is such a problem that some states do not allow use of wood treated with the soluble copper containing wood preservatives near waterways.

Another concern with soluble copper preservative products generally is that most preservative materials are manufactured at one of several central locations but are used in disparate areas and must be shipped, sometimes substantial distances. The cost of providing and transporting the liquid carrier for these soluble products can be considerable, and the likelihood of severe biological impact is very high if transported soluble copper wood preservative material is spilled or accidentally released near a waterway.

Further, unlike CCA, all of these soluble copper-containing wood preservatives require a second organic biocide to be effective against some biological species. Therefore, wood preserved with these soluble copper-containing wood preservatives also contain a second biocide that is efficacious against one or more particularly troublesome species. The second biocide is often slightly water soluble or be emulsified, and may be composed of a triazole group or a quaternary amine group or a nitroso-amine group, and this biocide can be simply added to the fluid used for pressure treating the wood.

U.S. Pat. No. 5,110,822 describes a synergistic mixture of ferric dimethyldithiocarbamat with either 4,5-dichloro-2-n-octyl-3-isothiazolone or 2-methyl-3-isothiazolone. U.S. Pat. No. 4,752,297 describes a process of coloring wood with an iron salt, where a environmentally resistant colorant in wood is made by contacting the wood with aqueous iron salts of organic (carboxylic) acids. This patent also describes the benefits of having one or more preservative metals—copper, chromium, arsenic and zinc—in addition to the iron carbolylate material. A preferred colorant is ferric ammonium citrate. The colorants impart a brown color and prevent the wood from aging to a gray or green color. U.S. Pat. No. 4,539,047 describes painting wood to maintain a fresh appearance, with its paint comprising mineral spirits, unsaturated resin, wax, and a transparent ultraviolet-absorbing pigment, preferably where said pigment is a hydrated iron oxide pigment. Various methods of producing UV blocking iron oxide pigments are described in U.S. Pat. No. 2,558,304, the disclosure of which is incorporated by reference. U.S. Pat. No. 4,702,776 describes a method of manufacturing pigmentary iron oxide particulates. U.S. Pat. No. 4,220,688 describes a method of preserving wood by injecting tannins, especially tannic acid, and then injecting a metal salt, preferably iron salts, that will complex with the injected tannic acid and wood.

U.S. Published Patent Application No. 2003/0086979 A1 discloses a method for preserving the lignin in wood products by first treating wood with a soluble iron salt, preferably complexed or chelated to an organic ligand, and, optionally in combination with a biocidal agent, exposing the iron-impregnated wood to an oxidant solution to oxidize the iron component in the impregnated wood and removing the residual solution from the iron-impregnated wood. This multi-impregnation, multi-residue-removal-step process is expensive, time consuming, difficult, and leaves questions about the conversion of the soluble iron salt to the appropriate oxides and the effect of the oxidant on the wood and on the other included biocides.

### SUMMARY OF THE INVENTION

The principal aspect of the invention is the manufacture of an injectable iron-based particulate, and incorporation of this iron-based particulate wood preservative into wood and wood products. The preferred iron-based particulates comprise one or more very finely ground iron oxides. Alternately, the iron-based particulates may comprise one or more sparingly soluble iron salts which over time form iron oxides.

Another aspect of this invention relates to the method of manufacturing an injectable iron oxide particulate in combination with one or more of 1) a soluble copper complex, such as ammoniacal copper, copper monoethanolamine carbonate, or other copper-amine complexs; 2) an injectable, sparingly-soluble, copper salt particulate such as finely ground copper hydroxide, basic copper carbonate, basic copper sulfate, basic copper chloride, basic copper phosphate, basic copper phosphosulfate, and the like; 3) an injectable, very finely ground copper(I) oxide; 4) an injectable, sparingly-soluble zinc-containing particulate, such as filely ground zinc oxide, basic zinc carbonate, zinc hydroxide, zinc phosphate, and the like; 5) an injectable, sparingly-soluble tin-containing particulate, such as filely ground tin oxide, tin hydroxide, and the like; 6) an injectable emulsion of organic particulates such as triazoles, quaternary ammonium compounds, carbamides, and other organic biocides, which may also include a solubilizing amount of oil or solvent; 7) an injectable, finely ground solid organic biocide or combinations of biocides, or any combinations thereof. Another aspect of this invention relates to a method of injecting the iron-based particulate, optionally including one or more of the seven other preservative systems listed above, into wood. Another aspect of the invention relates to a preservative-treated wood product comprising an injectable iron-based particulate, optionally in combination with one or more of the seven other preservative systems listed above.

The presence of the iron-containing material contributes to the color and appearance of the treated wood as it ages, and also in certain conditions reduces UV-promoted degradation of the wood substrate and of preservatives. In limited circumstances, iron compounds themselves can exhibit biocidal activity. U.S. Pat. No. 6,770,674 describes a potassium iron oxalate material that is useful in repelling certain mollusks, and notes that this material can advantageously be incorporated into non-fouling paint.

One embodiment of this invention is an effective, long-lasting, environmentally responsible, low-staining/coloring, inexpensive, non-corrosion-inducing, injectable, iron-containing particulate preservative treatment for wood and wood products that is substantially free of hazardous material. In one embodiment, the preservative is substantially free of copper, e.g., having less than 5%, preferably less than 1%, for example 0% or less than 0.3% by weight of copper relative to the weight of injectable, iron-containing particulates. Such embodiments are particularly useful in sensitive marine applications where copper may leach from wood and adversely impact the sensitive marine bioorganisms.

Biocidal compositions described in this application are also useful in other applications, particularly in paints and coatings, but also in foliar applications. Often, especially for substantially water-insoluble biocides, smaller particles provide a greater degree of biocidal protection, as well as increased tenacity, also known as “rainfastness.” One problem with small particles is the well-known problem of photolysis, where the efficacy of biocides is quickly compromised due to exposure of the small particles of biocide in the field to UV radiation. Another aspect of this invention is the incorporation of an effective amount of UV-absorbing materials, particularly very submicron-sized iron oxides, onto particulates of solid biocide.

Further, the treatment may reduce corrosion. U.S. Pat. No. 5,030,285 teaches pigments comprising zinc oxide, ferric phosphate, and ferrous phosphate, which provides an anti-corrosive effect. Additionally, zinc phosphate can also provide a anti-corrosion property.

### DETAILED DESCRIPTION OF THE INVENTION

Unless otherwise specified, all compositions are given in “percent”, where the percent is the percent by weight based on the total weight of the entire component, e.g., of the particle, or to the injectable composition. In the event a composition is defined in “parts” of various components, this is parts by weight wherein the total number of parts in the composition is between 90 and 110.

By “effective” we mean the iron-based particulates (e.g., iron oxide particulates) are sufficiently distributable through the wood product so as to provide an ultraviolet-protective activity of iron in the wood matrix. By “bio-active” we mean the injected preservative treatment, which includes one or more biocides, is sufficiently biocidal to one or more of fungus, mold, insects, and other undesired organisms which are normally the target of wood preservatives such that these organisms avoid and/or can not thrive in the treated wood.

Leaching from, for example, wood is a function of particle size and the solubility of the metal oxides and/or sparingly soluble metal salts. Generally, the leaching rate from dispersed particulates is controlled by 1) diffusion and boundary layer effects around the limited surface area available to water; 2) the activation energy needed to disrupt the crystal and to thereby cause dissolution, and 3) the absolute solubility of the material. Larger size particles have lower leach rates, while particles in a size range from about 1 to 10 nanometers, under certain circumstances, will not have a leach rate much different than that of an injected salt solution.

In preferred embodiments of this invention, at least about 50% by weight of the biocide-containing particulates have a size greater than about 40 nanometers. In one preferred embodiment, at least about 80% by weight of the iron-containing particulates have a size between about 0.05 microns and about 0.4 microns.

As used herein, particle diameters may be expressed as “dₓₓ” where the “xx” is the weight percent (or alternately the volume percent) of that component having a diameter equal to or less than the dₓₓ. The d50 is the diameter where 50% by weight of the component is in particles having diameters equal to or lower than the d₅₀, while just under 50% of the weight of the component is present in particles having a diameter greater than the d₅₀. Particle diameter is preferably determined by Stokes Law settling velocities of particles in a fluid, for example with a Model LA 700 or a CAPA™ 700 sold by Horiba and Co. Ltd., or a Sedigraph™ 5100T manufactured by Micromeritics, Inc., which uses x-ray detection and bases calculations of size on Stoke's Law, to a size down to about 0.2 microns. Smaller sizes are preferably determined by a dynamic light scattering method, preferably with a Coulter™ counter.

As used herein, the term “organic biocide” also includes organometallic biocides. By “substantially insoluble” (or “sparingly soluble” as the term relates to organic biocides), we mean the organic biocide has a solubility in water of less than about 0.1%, and most preferably less than about 0.01%, for example in an amount of between about 0.005 ppm and about 1000 ppm, alternatively between about 0.1 ppm and about 100 ppm or between about 0.01 ppm and about 200 ppm. A “sparingly soluble” salt as used herein has a Ksp in pure water between about 10-8 to about 10-24 for salts with only one anion, and from about 10-12 to about 10-27 for salts with two anions. Preferred sparingly soluble salts have a Ksp between about 10⁻¹⁰ to about 10-21. As used herein, preferred sparingly soluble inorganic salts includes salts with a Ksp of between about 10-12 to about 10-24 for salts with only one anion, and from about 10-14 to about 10-27 for salts with two anions.

By “substantially free of hazardous material” we mean the preservative treatment is substantially free of materials such as lead, arsenic, chromium, and the like. By substantially free of lead we mean less than about 0.1% by weight, preferably less than about 0.01% by weight, more preferably less than about 0.001% by weight, based on the dry weight of the wood preservative. By substantially free of arsenic we mean less than about 5% by weight, preferably less than about 1% by weight, more preferably less than about 0.1% by weight, for example less than about 0.01% by weight, based on the dry weight of the wood preservative. By substantially free of chromium we mean less than about 0.5% by weight, preferably less than about 0.1% by weight, more preferably less than about 0.01% by weight, based on the dry weight of the wood preservative.

By “environmentally responsible” we mean the wood preservative leaches copper, chromium, and arsenate at a rate less than half the rate of copper, chromium, and arsenate leaching from CCA-treated wood or wood products. Generally, the wood treated with the preservatives of the current invention is free of chromium and arsenate, but it may include a copper component alone or to complement the bioactivity of an organic biocide component. Preferably, the leaching of copper from wood or a wood product treated with this invention will be less than the rate, preferably less than half the rate, of copper leaching from CCA-treated wood or wood products under similar conditions. Additionally, environmentally responsible wood preservatives are beneficially substantially free of organic solvents. By substantially free we mean the treatment comprises less than about 10% organic solvents, preferably less than about 5% organic solvents, more preferably less than about 1% organic solvents, for example free of organic solvents, based on the weight of the wood preservative.

By “injectable” we mean that the wood preservative particulates are able to be pressure-injected into wood, wood products, and the like to depths normally required in the industry, using equipment, pressures, exposure times, and procedures that are the same or that are substantially similar to those currently used in industry. Pressure treatment is a process performed in a closed cylinder that is pressurized, forcing the chemicals into the wood. Retention levels for the various components of the preservative system are primarily dependent on three variables: the type of wood used, the type of preservative used, and the use of the wood after treatment.

Injectability into wood requires the particulates be substantially free of the size and morphology that will tend to accumulate and form a filter cake, generally on or near the surface of the wood, that results in undesirable accumulations on wood in one or more outer portions of the wood and a deficiency in an inner portion of the wood. Injectability is generally a function of the wood itself, as well as the particle size, particle morphology, particle concentration, and the particle size distribution.

The requirements of injectability for substantially round, e.g., the diameter in one direction is within a factor of two of the diameter measured in a different direction, rigid particles generally are 1) that substantially all the particles, e.g., greater than about 98% by weight, have a particle size with diameter equal to or less than about 0.5 microns, preferably equal to or less than about 0.3 microns, for example equal to or less than about 0.2 microns, and 2) that substantially no particles, e.g., less than about 0.5% by weight, have a diameter greater than about 1.5 microns, or an average diameter greater than about 1 micron, for example. We believe the first criteria primarily addresses the phenomena of bridging and subsequent plugging of pore throats, and the second criteria addresses the phenomena of forming a filter cake. Once a pore throat is partially plugged, complete plugging and undesired buildup generally quickly ensues.

However, there are minimum preferred particulate diameters for the biocides incorporated into the wood treatment, which depend somewhat on the biocides, particularly the sparingly soluble copper and/or zinc salts, that are in the particulates. If the sparingly soluble salts have a high solubility, then very small particulates having a large surface to mass ratio will result in too high an initial metal ion concentration, and too fast a rate of metal leaching, compared to preferred embodiments of this invention. Generally, it is preferred that at least about 80% by weight of the particles be above about 0.01 microns in diameter, preferably greater than about 0.03 microns, for example greater than about 0.06 microns in diameter.

By injectable, unless otherwise specified we mean injectable into normal southern pine lumber. This invention also encompasses injecting the particulates into other woods as well as into, for example, heartwood. Selected other woods and heartwood may require a smaller substantially lower criteria on particle dimensions for injectability, and such formulations can be made as discussed herein, but the formulation of most interest is a commercially operative formulation developed for normal Southern Pine. Such a formulation will typically be useful for all other woods, with the possible exception of selected heartwood. Such problems with heartwood are normally not a substantial concern, as the injected particulate material may form a partial protective filter cake around heartwood that protects the heartwood without causing unsightly accumulations of preservative on the wood, and also heartwood is naturally substantially resistant to attack by many bioorganisms and therefore may require less iron to constitute sufficient protection.

We have found three methods to improve injectability and/or to maintain injectability of particulates. These methods improve particle size distribution and/or morphology by wet milling, and chemically and physically stabilize the particulates by coating the particulates with selected materials.

Non-staining/Non-coloring—By “non-staining/non-coloring” we mean the wood preservative does not impart undesired color to the wood. Large particulates, or large agglomerations of smaller particulates, impose a visible and undesired color to the treated wood. Surprisingly, coloring is usually indicative of poor injectability. Individual particles of diameter less than about 1 micron, preferably less than about 0.5 microns, that are widely dispersed in a matrix do not color a wood product to any substantial degree. Filter cake forms unsightly coloring. An aggregation of particles, similar to filter-cake, could contribute unwanted color. Preferably about 100% by weight of the particles have an average diameter of less than about 1 micron, where an average diameter is the diameter measured by Stokes law settling (which may be assisted by centrifugation), or by preferably by dynamic light (X-ray) scattering or by Doppler light scattering. Even particulates having a size greater than about 0.5 microns can impart very visible color, and agglomerates of similar size have the same effect as do large particles. In a preferred embodiment of the invention, at least about 95%, e.g., at least about 99% by weight of the particulates/aggregates are smaller than about 0.5 microns in average diameter. More preferably, at least about 95%, e.g., at least about 99% by weight of the particulates/aggregates are smaller than about 0.35 microns in average diameter. Even more preferably, at least about 95%, e.g., at least about 99% by weight of the particulates/agreggates are smaller than about 0.3 microns in average diameter. Generally, it is preferred that at least about 90% by weight of the particles be above about 0.01 microns in diameter, preferably greater than about 0.03 microns, for example greater than about 0.06 microns. Certain metal compounds (e.g., iron oxides) that impart less color are preferred over other particles of comparable size.

The preferred method of production is a precipitation process, in the absence of organic solvents and the like. Preferably the reactants are of standard industrial quality, as opposed to higher levels of purity. The particles start with certain characteristics including size distribution and morphology, e.g., at least about 2% by weight of the particles have a diameter greater than about 1 micron, usually greater than about 1.5 microns, and generally must undergo subsequent treatment, e.g., milling, to make sure the particle size and particle size distribution are favorable for injection. Particles made by other processes, particularly emulsion precipitation processes and fuming processes, are not sufficiently cost effective to manufacture commercially acceptable iron particulates for wood preservation.

It is known that nanoparticles can be formed, for example, by micro-emulsion (or micelle) precipitation, and the like. The micelle system, where emulsions of small and uniformly sized micelles are used as nanoreactors in which the deposition of the metal salt is carried out, is known in the art. Such processes, however, while useful in forming very small particulates, are not useful in forming commercially acceptable wood preservative. The associated costs of adding and removing the solvents used to form the emulsions makes these processes economically less feasible for the purpose of forming an iron-containing and/or copper-containing injectable particulate wood preservation material.

We believe that any amines present in soluble iron treatments—alkanolamines, ammonia, and the like—are corrosive to metals. As a result, the wood preservative can advantageously be substantially free of any amines, other than certain selected amines that may be used as a supplemental biocide. By “substantially free” we mean the treatment comprises less than about 10% amines, preferably less than about 5% amines, more preferably less than about 1% amines, for example completely free of amines, based on the weight of the iron in the wood preservative. Alternatively, the term “substantially free” in this context can mean there is less than about one amine molecule or moiety per four iron atoms, preferably less than about one amine molecule or moiety per ten iron atoms. Again, amines that are used as supplemental biocides, if any, are excluded from this limitation.

Another embodiment of the invention is an injectable iron-based and/or copper-based particulate preservative treatment for wood that is substantially free of bio-available nitrogen, and even more preferably substantially free of bio-available nitrogen and bio-available carbon. By “substantially free of bio-available nitrogen,” we mean the treatment comprises less than about 10% of nitrates and organic nitrogen, preferably less than about 5% of nitrates and organic nitrogen, more preferably less than about 1% of nitrates and organic nitrogen, for example less than about 0.1% of nitrates and organic nitrogen, based on the weight of the iron in the wood preservative. In most of the soluble or complexed iron treatments, there are between 1 and 4 atoms of organic nitrogen that act as a complexer or carrier for one atom of iron. In the preferred embodiments of this invention, there is less than about 0.3 atoms, preferably less than about 0.1 atoms, for example less than about 0.05 atoms of organic nitrogen per atom of iron in the wood preservative treatment. Again, organic nitrogen-containing compounds that are used specifically as supplemental biocides are excluded from this limitation. By substantially free of bio-available carbon, we mean the treatment comprises less than about 30% of bio-available organic material (defined as material that is degradable or that will during the lifespan of the treatment become degradable), preferably less than about 10% of bio-available organic material, more preferably less than about 1% of bio-available organic material, based on the weight of the iron in the wood preservative. Again, organic compounds that are used as supplemental biocides, if any, are excluded from this limitation. It is believed that the presence of bio-available organic carbon may encourage the growth of certain molds.

Substantially crystalline—By “substantially crystalline” we mean, for example, greater than about 30%, preferably greater than about 50%, by weight of the metal compound, e.g., iron oxide, is crystalline. A material is substantially crystalline if the material gives the distinctive X-ray diffraction patterns of the crystalline entity (relating to d spacing, not present in the amorphous material). A convenient technique for assessing the crystallinity relative to the crystallinity of known crystalline compounds, (e.g., metal salts) is the comparison of the relative intensities of the peaks of their respective X-ray powder diffraction patterns. The degree of crystallinity can be determined by, for example, determining the sum of the X-ray diffraction peak heights (for the same sample size) in terms of arbitrary units above background, and then comparing the summed peak heights of the substantially crystalline material in, for example, the iron-based particulates with the corresponding peak heights of the known crystalline material. This procedure utilizes, for example, only the strongest four peaks. When, for example, the numerical sum of the peak heights of the material in a particulate is about 30 percent of the value of the sum of the peak heights of the same known crystalline iron salt, then the product is about 30 percent crystalline and is substantially crystalline. The preferred method for determining crystallinity is by calorimetry, by measuring the heat of dissolution of the sample in a solvent and comparing this heat with the measured heats of amorphous and crystalline standard of the same compound, provided the dissolution of the crystalline compound is substantially different than the dissolution of the corresponding amorphous compound. In some embodiments, at least about 20%, about 30%, about 50%, or about 75% of the weight of the copper or iron-based particles may be composed of the substantially crystalline (or amorphous sparingly soluble) copper or iron compound.

Several of the metal compounds (e.g., copper compounds and/or iron oxides) described herein are available in crystalline and in amorphous phases. Generally crystallinity is preferred, as the lattice energy of the crystal is expected to slow down dissolution. However, amorphous metal compounds are useful in the invention, and for the less soluble salts the amorphous phases may be preferred over crystalline phases. Amorphous sparingly soluble compounds can be treated with one or more coatings, or can be made of a particular size, or of more insoluble compounds, such that the amorphous material may easily have release and leach characteristics like the substantially crystalline salts.

Iron-Based Particulate—As used herein, the term “iron-based particulate” means a particle having a size between about 0.01 microns and about 0.7 microns that comprises at least one substantially crystalline (or amorphous sparingly soluble) iron compound (e.g., an iron oxide). The term “finely ground” when referring to an iron-based particulate, or any other metal or non-metal (e.g., organic) particulate, means particles having a d₅₀ less than about 0.7 microns. The term “particle” is used interchangably with the term “particulate,” while the term “nanoparticle” refers to particles having a size less than about 0.01 microns in diameter. The term “iron” includes, unless specifically stated otherwise, the cuprous ion, the cupric ion, or mixture thereof, or combination thereof. The term “iron-based” means the particle comprises at least about 20%, 30%, 50%, or 75% by weight of one or more substantially crystalline (or amorphous sparingly soluble) iron compounds. In another embodiment, essentially all (e.g., more than 95%) of the weight of the iron-based particles is composed of substantially crystalline (or amorphous sparingly soluble) iron compound.

It is recognized that some embodiments encompassed by this invention may not meet all of the objects or characteristics of the preferred embodiments of the invention as described above. In preferred embodiments of the invention, the injectable material will meet any and preferably most of the criteria listed above for the effective, long-lasting, environmentally responsible, non-staining/coloring, inexpensive, non-corrosion-inducing, injectable, substantially crystalline (or amorphous sparingly soluble), iron-based particulate preservative treatment for wood and wood products that is substantially free of hazardous material. In further preferred embodiments of the invention, the injectable iron-based particulates will meet any and preferably most of the criteria listed above for the effective, long-lasting, environmentally responsible, non-staining/coloring, inexpensive, less-corrosion-inducing, injectable, substantially crystalline (or amorphous sparingly soluble), iron-based particulate preservative treatment for wood and wood products that is substantially free of hazardous material.

In one embodiment, exemplary wood preservatives comprise iron-based particles having a size distribution in which at least about 50% of particles have a diameter smaller than about 0.5 μm, smaller than about 0.25 μm, smaller than about 0.2 μm, or smaller than about 0.15 μm. A preferred particle sizing technique is a sedimentation or centrifugation technique based on Stoke's law. An exemplary preservative of the invention comprises particles comprising a sparingly soluble iron salt having a d₅₀ of less than about 500 nanometers, for example less than about 250 nanometers, or less than about 200 nanometers. In one embodiment, the d₅₀ is at least about 25 nanometers, for example, at least about 50 nanometers. In another embodiment, the d_{98.5} of the sparingly soluble iron salts is about 0.7 microns or less, and the d_{99.5} is about 1.5 microns or less.

Iron-containing salts useful in the compositions and methods according to the invention can advantageously include Fe(II) salts, Fe(III) salts, and/or combinations thereof. Examples of such iron-containing salts can include, but are not limited to, Fe(OH)₂, FeS, FeAsO₄, FePO₄, quinaldates, and the like, and combinations thereof. Additionally or alternately, suitable iron-containing salts can have solubilities in water such that the Kₛₚ value of the salt is from about 10-12 to about 10⁻²⁷, or alternately from about 10⁻¹⁴ to about 10⁻²⁴.

Other examples of suitable iron-containing salts also include, but are not limited to, iron oxides such as FeO, Fe₂O₃, Fe₃O₄, wustite, hematite, magnetite, maghemite, ferrihydrite, delafossite, srebrodolskite, hercynite, galaxite, magnesioferrite, jacobsite, trevorite, cuprospinel, franklinite, chromite, manganochromite, cochromite, nichromite, coulsonite, qandilite, ulvospinel, brunogeierite, iwakiite, donathite, filipstadite, schafarzikite, versiliaite, apuanite, magnesiotaaffeite, bixbyite, akimotoite, ilmenite, ecandrewsite, melanostibite, magnesiohogbomite-2N3S, magnesiohogbomite-6N6S, zincohogbomite, freudenbergite, kamiokite, mengxianminite, yimengite, hawthorneite, haggertyite, batiferrite, nezilovite, magnetoplumbite, zenzenite, lindqvistite, plumboferrite, bartelkeite, landauite, loveringite, lindsleyite, senaite, latrappite, romeite, bismutostibconite, jixianite, muratite, scheteligite, zirconolite, stannomicrolite, ferritungstite, armalcolite, pseudobrookite, pseudorutile, mongshanite, kleberite, squawcreekite, ilmenorutile, struverite, tapiolite, ferrotapiolite, tripuhyite, jeppetite, priderite, henrymeyerite, vernadite, ferberite, sanmartinite, wolframoixiolite, koragoite, ixiolite, qitianlingite, ferrotitanowodginite, ferrowodganite, ferrocolumbite, ferrotantalite, hiarneite, muskoxite, varlamofite, kazakhstanite, bokite, ekatite, cafarsite, stenhuggarite, lazarenkoite, karibibite, ludlockite, fetiasite, schneiderhohnite, mandarinoite, blakeite, emmonsite, keystoneite, kinichilite, zemannite, walfordite, cuzticite, yecoraite, gramaccioliite, and the like; iron hydroxides such as Fe(OH)₂, Fe(OH)₃, amakinite, bernalite, iowaite, natanite, mushistonite, jeanbandyite, stottite, and the like; iron oxide-hydroxides such as goethite, lepidocrocite, akaganeite, feroxyhyte, magnesiohogbomite-2N2S, ferrohogbomite, nolanite, rinmanite, magnesionigerite, ferronigerite, romeite, jixianite, scheteligite, stannomicrolite, ferritungstite, carboirites, graeserite, derbylite, vemadite, janggunite, carmichaelite, bamfordite, varlamofite, ekatite, karibibite, sonoraite, mackayite, juabite, eztlite, and the like; iron sulfides; iron sulfates, iron sulfites; iron phosphates; iron phosphites; or other iron-containing salts such as rodalquilarite, poughite, and the like; and combinations thereof.

Exemplary iron-based particles comprise one or more of iron metal, an iron oxide, an iron hydroxide, iron carbonate, and an iron salt that is sparingly soluble. In some embodiments, it is preferred that the wood preservatives comprise iron-based particles that comprise at least about 20%, for example, at least about 30%, at least about 40%, or at least about 50% by weight iron, based on the weight of the particle.

There are a large number of references describing how to make small metal-containing particles. U.S. Published Patent Application No. 2003/0077219 A1 describes a method for producing copper salts from at least one cupriferous reactant and one additional reactant, where micro-emulsions are prepared from two reactants while employing at least one block polymer to obtain intermediate products with a particle size of less than 50 nm, preferably 5 to 20 nm. Material can be adjusted to specific applications through the appropriate doping of foreign ions. This application teaches wood treatment applications, stating copper compounds that have been produced pursuant to the present invention can penetrate more easily and more deeply into the wood layers under treatment due to their quasi atomic size. Modifying the process of this application to make particulates greater than 50 nanometers in diameter, for example between about 100 and about 200 nanometers in diameter, can be useful provided the solvent serves a subsequent purpose of solvating one or more organic biocides, to partially bind the organic biocides to the particulate by partially or completely removing the solvent by evaporation.

There are also numerous methods of preparing very small particles of iron salts, generally similarly to the copper salts described above. The simplest and by far the least expensive method of producing small particles is a standard precipitation of admixing two solutions, one containing soluble iron and one containing the desired anion, and some particles resulting from slightly modified precipitation processes are of a size that may be injected into the wood. The most useful modification is simply adding small quantities of anion to a concentrated solution of the cation, or vice versa, with vigorous stirring. Such processes are also desirable because the cost of counter-ions (those ions that form the salts that are admixed, but that are not incorporated into the substantially crystalline (or amorphous sparingly soluble) iron material) is negligible. Further, the material need not be ultra-pure. Indeed, it is desirable to have one or more “contaminants” in the precipitating solutions. Smaller diameters can be obtained when the concentration of impurities such as Mg, Ca, Zn, Na, K, Cu, and Al in the suspension is high.

While such methods can provide small particles of selected substantially crystalline (or amorphous sparingly soluble) salts, these processes usually have a small fraction of particles that are unacceptably large. Generally, however, a few particles from a normal precipitation process are too big to be injectable. A very small fraction of particles having a particle size above about 1 micron causes, in injection tests on wood specimens, severely impaired injectability. Large particles, e.g., greater than about 1 micron in diameter, should be removed. Removal via filtering is not effective, as a large fraction of injectable particles will be caught on filters designed to remove the bigger particles. We have surprisingly found that milling, for example wet-milling, can advantageously modify particle size and morphology. Particles can be smoothed and large particles removed by continuous-process centrifuging. Alternately, as described above, we have surprisingly found that substantially crystalline (or amorphous sparingly soluble) iron-based particulates that are manufactured by a precipitation process, using conditions known in the art to produce small particles, can be readily milled into an injectable material by wet milling with a milling material such as about 0.5 mm diameter (or less) zirconium silicate in a matter of minutes.

In another embodiment, the iron-based particulates can have a substantial amount, e.g., at least about 0.5% by weight, for example at least about 2% by weight, but typically less than about 50% by weight, based on the weight of iron of one or more other cations, either dispersed within the substantially crystalline (or amorphous sparingly soluble) iron composition or substantially as a separate phase within the particulate.

Milling—Generally, the simple, inexpensive iron salt precipitation processes provide particles with a size too great for injection. Even for processes that provide very small median diameter particles, e.g., a few tenths of a micron in diameter, the precipitation process seems to result in a small fraction of particles that are larger than about 1 micron, and these particles plug up pores and prevent acceptable injectability. The size distribution of the injectable particles must have the vast majority of particles, for example at least about 95% by weight, preferably at least about 99% by weight, more preferably at least about 99.5% by weight, be of an average diameter less than about 1 micron, and advantageously the particles are not rod-shaped with a single long dimension. Average particle diameter is beneficially determined by Stokes Law settling velocities of particles in a fluid to a size down to about 0.2 microns. Smaller sizes are beneficially determined by, for example, a dynamic light scattering method or laser scattering method or electron microscopy. Generally, such a particle size and particle size distribution can be achieved by mechanical attrition of particles.

Attrition can be obtained, for example, by use of 1) a pressure homogenizer such as that manufactured by SMT Ltd. having about 400 kg/cm² of pressure at a flow rate of about 1 L/min., although such a system often requires the slurry to be processed overnight by processing in an ultrasonic homogenizer, such as is manufactured by Nissei Ltd., which is energy intensive; 2) by wet milling in a sand grinder charged with, for example, partially stabilized zirconia beads with diameter 0.5 mm; 3) alternately wet milling in a rotary sand grinder with partially stabilized zirconia beads with diameter of about 0.5 mm and with stirring at for example about 1000 rpm; or by 4) use of a wet-ball mill, 5) an attritor (e.g., manufactured by Mitsui Mining Ltd.), 6) a perl mill (e.g., manufactured by Ashizawa Ltd.,), or the like. Attrition can be achieved to a lesser degree by centrifugation, but larger particles can be simply removed from the composition via centrifugation. Removing the larger particulates from a composition can provide an injectable formulation. Said particulates can be removed by centrifugation, where settling velocity substantially follows Stokes law. While this process provides injectable slurries, a fraction of the iron-containing particulates that are separated thereby include both large particles as well as a portion of the injectable particles, and generally this material would be recycled by being dissolved and precipitated. Such a process adds an additional cost to forming the injectable iron-containing particulate wood treatment.

The most effective method of modifying the particle size distribution is wet milling. Beneficially, all injectable formulations for wood treatment should be wet-milled, even when the “mean particle size” is well within the range considered to be “injectable” into wood. Traditional precipitation techniques are known to produce particles with a median particle size between about 0.2 and about 6 microns, depending on the salts used as well as on various reaction conditions. However, when this material is slurried and injected into wood, unacceptable plugging is postulated to occur on the face of the wood. Careful examination would find that prior art precipitation processes typically result in at least a few weight percent of particles with a size over 1 micron, and this small amount of material is hypothesized to form the start of the plug (where smaller, normally injectable particles are subsequently caught by the plug). Wet milling with zirconium silicate media having a diameter of about 2 mm is believed to have no effect-wet milling for days likely results in only a marginal decrease in particle size, and the material would still not be injectable in commercial quantities.

However, we have surprisingly found that a milling process using about 0.5 mm high density zirconium silicate grinding media provides further efficient attrition, especially for the removal of particles greater than about 1 micron in the commercially available iron-based particulate product. The milling process usually takes on the order of minutes to achieve almost complete removal of particles greater than about 1 micron in size. This wet milling process is inexpensive, and all of the precipitate can be used in the injectable iron-containing particulate wood treatment. The selection of the milling agents is not critical, and can be zirconia, partially stabilized zirconia, zirconium silicate, and yttrium/zirconium oxide, for example, recognizing that the more dense materials give faster particle size attrition. The size of the milling material is believed to be important, even critical, to obtaining a commercially acceptable process. The milling agent material having a diameter of about 2 mm or greater are ineffective, while milling agent material having a diameter of about 0.5 mm is effective typically after about 15 minutes of milling. We believe the milling agent is advantageously of a diameter less than about 1.5 mm, preferably less than about 1 mm in diameter, for example between about 0.1 mm and about 1 mm, or alternately between about 0.3 mm and about 0.7 mm.

Milling is believed to break up larger particles. It would also break particles having one large dimension, e.g., rod-like particles, which are know to have injection problems. Milling can be combined with for example centrifugation to create a more uniform product. Alternatively, milling can be combined with a coating process to form a more stable material.

In one embodiment, the particles (e.g., iron oxide particles) are wet milled using a milling media (e.g., grinding media) comprising beads having a diameter between around 0.1 mm and around 0.8 mm and having a density greater than about 3 g/cc.

Soluble Substantially Crystalline Iron Salts—In any of the above-described embodiments, the substantially crystalline iron composition in iron-based particulates and/or iron-based particulate material can further comprise one or more soluble substantially crystalline iron salts, where the soluble substantially crystalline iron salts phase are stabilized against dissolution. Alternatively, the substantially crystalline iron composition in the iron-based particulates can comprise or consist essentially of one or more soluble substantially crystalline iron salts, where the soluble substantially crystalline iron salts phase are stabilized against dissolution. Such protection may be provided by encasing the soluble iron salts in a shell or a matrix of sparingly soluble iron salts or in insoluble iron salts.

In another embodiment, the iron-based particles may be essentially free of halogen, which means that the weight percent of halogen in the particles is less than about 2.5%. Preferably, the weight percent of halogen in iron-based particles that are essentially free of halogen is less than about 1%. The iron-based particles may be free of halogen.

In one embodiment of the invention, the iron-based particles are substantially free of at least one of the halogens, for example, at least one of fluorine, chlorine, bromine, and iodine. Preferably, the weight percent of the at least one halogen in particles that are substantially free of the at least one halogen is less than about 25%, for example, less than about 20%, 15%, 10%, or 5%. In another embodiment, the iron-based particles are essentially free of at least one of the halogens, for example at least one of fluorine, chlorine, bromine, and iodine. Particles that are essentially free of at least one halogen have less than about 2.5% of the at least one halogen. Preferred particles have less than about 1% of the at least one halogen. In one embodiment, the iron based particles are completely free of at least one of the halogens.

Coatings For The Iron-Based Particulates.

In any of the above-described embodiments, the substantially crystalline iron composition in iron-based particulates and/or iron-based particulate material can further comprise one or more materials disposed on the exterior of the particles to inhibit dissolution of the underlying substantially crystalline (or amorphous sparingly soluble) iron material at least for a time necessary to prepare the formulation and inject the prepared wood treatment composition. Over time, however, there can be unfavorable particle growth via dissolution and precipitation processes and also particle growth via agglomeration. Also, the particulates can be very susceptible to premature dissolution if the slurry is formed with an acidic water. Additionally or alternatively, the acid-soluble particles can be coated with a substantially inert coating, for example, a trace outer coating of, e.g., iron phosphate or iron sulfide, or a coating of a polymeric material such as a dispersant, or with a thin hydrophobic coating, or any combination thereof. In one embodiment the particles are treated with a dispersing material which is substantially bound to the particles.

The milled iron-based particles described above are readily slurried and injected into wood after the milling process. Generally, however, milling is done well before the particles are slurried and injected. The particles may be shipped in a dry form or in a wet form. The milled particles may be transported to a site as a dry mix or as a concentrated slurry, which is then formed into an injectable slurry, and then after some indeterminate storage time the particles may be injected into wood. Particulates in solution have a tendency to grow over time by 1) the thermodynamically driven tendency of sub-micron particles in solution to grow by a dissolution/re-precipitation process, where there is a greater tendency for small particles to slowly dissolve and for the salts to re-precipitate on the larger crystals. It is not uncommon in unstabilized slurries, for the median particle size to increase by about 50% over a period of a day or two. The goal is to simultaneously achieve the critical particle size, particle size distribution, and particle stability at a cost where the material can be commercially used and at the point where the material will be commercially used. Therefore, it is advantageous to have a coating on the particle to substantially hinder dissolution of a particle that is more than sparingly soluble while the particle is slurried. But, the coating should not overly hinder dissolution of the particle in the wood matrix. Further, no coating to hinder dissolution is typically desirable for iron particulates that are already sparingly soluble or virtually insoluble.

Inorganic Coating—The substantially crystalline (or amorphous sparingly soluble) iron-based material can be stabilized by a partial or full coating of an inorganic salt. The manufacturing process is amenable to the formation of a substantially inert inorganic coating on the particle that will be of such low thickness that the coating will not substantially hinder particle dissolution in the wood. The preferred coatings are very low solubility metal salts of the underlying metal cations, and can depend upon the particular size distribution and particle morphology that may exist. A coating of a very low solubility salt can substantially arrest the dissolution/re-precipitation process by severely limiting the amount of iron that can dissolve. The coating, however, is typically intended as a mechanical protection. Exposed portions of the underlying substantially crystalline (or amorphous sparingly soluble) iron-based particulates are still subject to dissolution. Further, the inorganic coating is generally at most about a few atoms to about a few nanometers in depth.

An inorganic coating can be formed during and immediately after the particulate precipitation process, for example, by adding after admixing the dissolved iron solution and the dissolved anion solution together to form the “precipitation solution,” e.g., after precipitation of the substantially crystalline (or amorphous sparingly soluble) particulates has begun.

The particles may be wet-milled using a very fine milling material and a fluid containing a source of anions, e.g., sulfate ions, phosphate ions, or less preferably (because of odor and handling problems) sulfide ions. In one embodiment, the milling liquid can have a pH between about 6 and about 9.5, for example between about 7 and about 8.5. If sulfide is added, the pH should be above 8, preferably above 9. Such milling in the anion-containing milling fluid, for example for a time ranging from 5 minutes to 4 hours, typically from 10 minutes to 30 minutes is thought to promote the formation of a thin coating of iron salt over the substantially crystalline (or amorphous sparingly soluble) iron-containing particulate material. As the coating is probably only a few atoms/layers in thickness, the coating should dissolve in good time within the wood so as not to impair exposure of the underlying substantially crystalline iron-containing particulates in the wood.

In some embodiments, a portion iron-containing particulates are stabilized with a coating, while another portion of particulates are not subject to such stabilization. For instance, advantageously only the very small particulates, e.g., smaller than about 0.05 microns in diameter, are stabilized by a low-solubility covering layer.

The invention also embraces embodiments where particles are substantially free of an inorganic coating.

Organic Coating—Iron-based particles of the invention may be used directly to preserve wood or wood products. The iron-based particles or mixtures thereof may additionally comprise an organic coating, e.g., a organic layer that partially or completely covers the exterior surface area of the particulates. The protective organic layer may additionally function as one or more other active agents, as discussed infra. This organic coating can comprise a variety of materials having a variety of functions over and above being an organic layer acting as a protective layer temporarily isolating the sparingly soluble salt from the aqueous carrier to slow dissolution of particulates in the slurry, including: 1) as an organic biocide carrier; 2) as a dispersing/anti-aggregation/wettability modifying agent; 3) as one or more biocides; or any combinations thereof.

In one embodiment, at least some of the particulates are coated with an organic protective coating. The particulates may have been previously coated with an inorganic coating. The organic coating should provide a thin layer of organic material that at least partially coats the particulate and for a period of time reduces the tendency of the sparingly soluble iron salts in the particulates to dissolve in the slurry.

Generally such coatings are extremely thin, with a particulate comprising, for example, between about 0.1% to about 50% by weight, more typically from about 0.5% to about 10%, of the weight of the above-mentioned sparingly soluble salts. The coating may cover only a portion of the exterior surface area, for example only 50% of the external surface area of a particulate.

In some embodiments, the coating can comprise oils such as light oils, dehydrating oils, hydrophobic oils, and the like; organic compounds having one or more polar functional groups which increase adherence, such as mono- and/or poly-carboxylic acids (that may be at least partially neutralized); polymeric films; organic biocides, such as those having the functionality of an amine, an azole, a triazole, or the like; surfactant and/or disbursing agents; anti-coagulating agents, such as sulfated ionomers or amphoteric agents; or the like; or a combination thereof.

An organic coating may be formed by contacting particulates with an organic composition containing the materials to be deposited onto the exterior surface of the particle. The contacting may occur in a slurry or may be done with a paste of water-wetted particulates or may be done with dried particulates. The less free water, the easier it is to promote adherence between the organic composition and the particulates.

Heating a mixture of particulates and the organic composition will also help the organic composition wet and adhere to the particulates. Advantageously, in one embodiment most of the solvent of the organic composition is volatile and is removed prior to injection of the particulates into the wood. If the organic composition contains additional biocides, this will leave a thin layer of a more concentrated biocide in heavier oils and/or binders than was found in the original organic composition. The organic coating generally becomes more adherent if the coated particulates are allowed to age, and or are subjected to heat, for example to 35° C. or above, for a period of about an hour, for example.

Incorporating some solvents, typically polar solvents, e.g., at least about 10%, for example at least about 30% or at least about 50% by weight, may help the organic composition wet the particulates, and tend to allow thinner organic layers to be deposited. Exemplary solvents can include, but are not limited to one or more of alcohols, amides, ketones, esters, ethers, glycols, and the like. Solvents are lower molecular weight and higher volatility than oils, and solvents may be stripped from the organic coating before slurrying the particles or during kiln drying of the wood. The organic composition may therefore comprise optional solvents and/or diluents, for example a mixture of an oily or oil-type organochemical compound and a solvent of low volatility and/or a polar organochemical solvent or solvent mixture. Organochemical oils which are preferably employed are oily or oil-type solvents with an evaporation number above about 35° C. and a flash point of above about 30° C., preferably above about 45° C. Such water-insoluble, oily and oil-type solvents of low volatility which can be used include, but are not limited to, suitable mineral oils or their aromatic fractions or mineral-oil-containing solvent mixtures, e.g., white spirit, petroleum and/or alkyl benzene. Mineral oils include those with a boiling range from about 170° C. to about 220° C., spindle oil with a boiling range from about 250° C. to about 350° C., petroleum and aromatics with a boiling range from about 160° C. to about 280° C., oil of turpentine, and the like. The organic oily or oil-type solvents of low volatility can, in some instances, be replaced in part by organochemical solvents of high or medium volatility, with the proviso that the preferred solvent mixture also has an evaporation number above about 35° C. and a flash point above about 30° C., preferably above about 45° C., and that the biocides and/or other compounds are soluble or emulsifiable in this solvent/oil mixture. In one embodiment, aliphatic organochemical solvents containing hydroxyl, ester, and/or ether groups are used, e.g., glycol ethers, esters, or the like.

Advantageously, the organic composition can comprise binders to wet and adhere to the particulate, which include, but are not limited to, synthetic resins binding drying oils; binders comprising an acrylate resin, a vinyl resin (e.g., polyvinyl acetate), a polyester resin, a polycondensation or polyaddition resin, a polyurethane resin, an alkyd or modified alkyd resin (preferably of medium oil length), a phenol resin, a hydrocarbon resin (e.g., indene/coumarone resin), a silicone resin, drying vegetable oils, or the like, or a combination thereof; physically drying binders based on a natural and/or synthetic resin; or the like; or any combination thereof. Pertinent agricultural drying oils include, but are not limited to, linseed, soybean, canola, rapeseed, sunflower, tung, and castor oils, as well as combinations thereof.

This organic coating can comprise a variety of materials having a variety of functions.

1) Surface-Active Agents—Agents improving the suspension of the particulates can include, but are not limited to, dispersants such as phenyl sulfonates, alkylnaphthalene sulfonates and polymerized naphthalene sulfonates, polyacrylic acids and their salts, polyacrylamides, polyalkoxydiamine derivatives, polyethylene oxides, polypropylene oxide, polybutylene oxide, taurine derivatives and their mixtures, sulfonated lignin derivatives, and the like. Surfactants can include, but are not limited to, anionic surfactants, cationic surfactants, nonionic surfactants, zwitterionic surfactants, or combinations thereof. Dispersants can be used at about 0.1% to about 50%, preferably about 0.5% to about 20% or about 5% to about 10% by weight, of the particulate product.

2) Organic Biocides—As previously stated, the particles may be combined with one or more additional moldicides, or more generally biocides, to provide added biocidal activity to the wood or wood products. Certain preservative treatments comprise iron-based particles having one or more additional organic biocide(s) that are bound, such as by adsorption, to a surface of the particles. Wood and wood products may be impregnated substantially homogeneously with (a) iron-based particles of the invention and (b) a material having a preservative function, such as a material bound to the surface of the iron-based particles. By “substantially homogeneously,” we mean as averaged over a volume of at least a cubic inch, as on a microscopic scale there will be volumes having particulates disposed therein and other volumes within the wood that do not have particulates therein. Thus, the distribution of preservative function within the wood or wood product is preferably not heterogeneous.

When used in conjunction with the iron-containing particles according to the invention, the absolute quantity of organic biocides is typically very low. In general, the biocides are present in a use concentration of from about 0.1% to about 20%, preferably about 1% to about 5%, based on the weight of the iron salts. The sparingly soluble iron-salt particulates of this invention are typically expected to be added to wood in an amount equal to or less than about 0.25 pounds as iron per cubic foot. The organic biocides are often insoluble in water, which is the preferred fluid carrier for injecting the wood preservative treatment into wood. Thus, achieving adequate distribution of the biocide within the wood matrix can be problematic. In prior art formulations, the wood preservative may be, for example, admixed in a large excess of oil, and the oil emulsified with water and admixed with the soluble iron for injection into the wood. Problems can arise if the injection is delayed, or if the slurry has compounds which break the emulsion, and the like.

The greatest benefit is that, if desired, a portion or all of the organic biocides incorporated into the wood preservative treatment can advantageously be coated onto the particulates. By adhering the biocides on particulates, a more even distribution of biocide in ensured, and the iron is disposed with the biocide and is therefore best positioned to protect the biocide from those bio-organisms which may degrade or consume the biocide, as the iron-based particulate's ultraviolet light protection properties protect the organic biocide from degradation. Finally, a formulation with biocide adhering to particulates does not face the instability problems that emulsions face.

The biocides can be any of the known organic biocides. Exemplary organic biocides having a preservative function include compounds containing or composed of at least one of the following: azoles; triazoles; imidazoles; pyrimidinyl carbinoles; 2-amino-pyrimidines; morpholines; pyrroles; phenylamides; benzimidazoles; carbamates; dicarboximides; carboxamides; dithiocarbamates; dialkyldithiocarbamates; N-halomethylthio-dicarboximides; pyrrole carboxamides; oxine-iron, guanidines; strobilurines; nitrophenol derivatives; organo phosphorous derivatives; polyoxins; pyrrolethioamides; phosphonium compounds; polymeric quaternary ammonium borates; succinate dehydrogenase inhibitors; formaldehyde-releasing compounds; naphthalene derivatives; sulfenamides; aldehydes; quaternary ammonium compounds; amine oxides, nitroso-amines, phenol derivatives; organo-iodine derivatives; nitrites; quinolines; phosphoric esters; organosilicon compounds; pyrethroids; nitroimines and nitromethylenes; and mixtures thereof.

Exemplary biocides can include, but are not limited to, azoles such as azaconazole, bitertanol, propiconazole, difenoconazole, diniconazole, cyproconazole, epoxiconazole, fluquinconazole, flusiazole, flutriafol, hexaconazole, imazalil, imibenconazole, ipconazole, tebuoonazole, tetraconazole, fenbuconazole, metconazole, myclobutanil, perfurazoate, penconazole, bromuconazole, pyrifnox, prochloraz, triadimefon, triadlmenol, triffumizole, or triticonazole; pyrimidinyl carbinoles such as ancymidol, fenarimol, or nuarimol; chlorothalonil; chlorpyriphos; N-cyclohexyldiazeniumdioxy; dichlofluanid; 8-hydroxyquinoline (oxine); isothiazolone; imidacloprid; 3-iodo-2-propynylbutylcarbamate tebuconazole; 2-(thiocyanomethylthio) benzothiazole (Busan 30); tributyltin oxide; propiconazole; synthetic pyrethroids; 2-amino-pyrimidine such as bupirimate, dimethirimol or ethirimol; morpholines such as dodemorph, fenpropidin, fenpropimorph, spiroxanin or tridemorph; anilinopyrimdines such as cyprodinil, pyrimethanil or mepanipyrim; pyrroles such as fenpiclonil or fludioxonil; phenylamides such as benalaxyl, furalaxyl, metalaxyl, R-metalaxyl, ofurace or oxadixyl; benzimidazoles such as benomyl, carbendazim, debacarb, fuberidazole or thiabendazole; dicarboximides such as chlozolinate, dichlozoline, iprdine, myclozoline, procymidone or vinclozolin; carboxamides such as carboxin, fenfuram, flutolanil, mepronil, oxycarboxin or thifluzamide; guanidines such as guazatne, dodine or iminoctadine; strobilurines such as azoxystrobin, kresoxim-methyl, metominostrobin, SSF-129, methyl 2-[(2-trifluoromethyl)pyrid-yloxymethyl]-3methoxycacrylate or 2-[α{[(α-methyl-3-trifluoromethyl-benzyl)imino]oxy}-o-tolyl]glyoxylic acid-methylester-O-methyloxime (trifloxystrobin); dithiocarbamates such as ferbam, mancozeb, maneb, metiram, propineb, thiram, zineb, or ziram; N-halomethylthio-dicarboximides such as captafol, captan, dichlofluanid, fluorormide, folpet, or tolfluanid; nitrophenol derivatives such as dinocap or nitrothal-isopropyl; organophosphorous derivatives such as edifenphos, iprobenphos, isoprothiolane, phosdiphen, pyrazophos, or toclofos-methyl; and other compounds of diverse structures such as aciberolar-5-methyl, anilazine, blasticidin-S, chinomethionat, chloroneb, chlorothalonil, cymoxanil, dichlone, dicomezine, dicloran, diethofencarb, dimethomorph, dithianon, etridiazole, famoxadone, fenamidone, fentin, ferimzone, fluazinam, flusuffamide, fenhexamid, fosetyl-alurinium, hymexazol, kasugamycin, methasuifocarb, pencycuron, phthalide, polyoxins, probenazole, propamocarb, pyroquilon, quinoxyfen, quintozene, sulfur, triazoxide, tricyclazole, triforine, validamycin, (S)-5-methyl-2-methylthio-5-phenyl-3-phenyl-amino-3,5-dihydroimidazol-4-one (RPA 407213), 3,5-dichloro-N-(3-chloro-1-ethyl-1-methyl-2-oxopropyl)-4-methylbenzamide (RH7281), N-alkyl-4,5-dimethyl-2-timethylsilythiophene-3-carboxamide (MON 65500), 4-chloro-4-cyano-N,N-dimethyl-5-p-tolylimidazole-1-sulfonamide (IKF-916), N-(1-cyano-1,2-dimethylpropyl)-2-(2,4dichlorophenoxyy)-propionamide (AC 382042), or iprovalicarb (SZX 722). Also included are the biocides including pentachlorophenol, petroleum oils, phenothrin, phenthoate, phorate, as well as trifluoromethylpyrrole carboxamides and trifluoromethylpyrrolethioamides described in U.S. Pat. No. 6,699,818; triazoles such as amitrole, azocylotin, bitertanol, fenbuconazole, fenchlorazole, fenethanil, fluquinconazole, flusilazole, flutriafol, imibenconazole, isozofos, myclobutanil, metconazole, epoxyconazole, paclobutrazol, (±)-cis-1-(4-chlorophenyl)-2-(1H-1,2,4-triazol-1-yl)-cycloheptanol, tetraconazole, triadimefon, triadimenol, triapenthenol, triflumizole, triticonazole, uniconazole and their metal salts and acid adducts; Imidazoles such as Imazalil, pefurazoate, prochloraz, triflumizole, 2-(1-tert-butyl)-1-(2-chlorophenyl)-3-(1,2,4-triazol-1-yl)-propan-2-ol, thiazolecarboxanilides such as 2′,6′-dibromo-2-methyl-4-trifluoromethoxy-4′-trifluoromethyl-1,3-thiazole-5-carboxanilide, azaconazole, bromuconazole, cyproconazole, dichlobutrazol, diniconazole, hexaconazole, metconazole, penconazole, epoxyconazole, methyl (E)-methoximino[α-(o-tolyloxy)-o-tolyl)]acetate, methyl (E)-2-{2-[6-(2-cyanophenoxy)-pyrimidin-4-yl-oxy]phenyl}-3-methoxyacrylate, methfuroxam, carboxin, fenpiclonil, 4(2,2-difluoro-1,3-benzodioxol-4-yl)-1H-pyrrole-3-carbonitrile, butenafine, 3-iodo-2-propinyl n-butylcarbamate; triazoles such as described in U.S. Pat. Nos. 5,624,916, 5,527,816, and 5,462,931; the biocides described in U.S. Pat. No. 5,874,025; 5-[(4-chlorophenyl)methyl]-2,2-dimethyl-1-(1H-1,2,4-triazol-1-yl-methyl)cyclopentanol; imidacloprid, 1-[(6-chloro-3-pyridinyl)-methyl]-4,5-dihydro-N-nitro-1H-imidazole-2-amine; methyl(E)-2-[2-[6-(2-cyanophenoxy)pyrimidin-4-yloxy]phenyl]3-methoxyacrylate, methyl(E)-2-[2-[6-(2-thioamidophenoxy)pyrimidin-4-yloxy]phenyl]-3-methoxyacrylate, methyl(E)-2-[2-[6-(2-fluorophenoxy)pyrimidin-4-yloxy]phenyl]-3-methoxyacrylate, methyl(E)-2-[2-[6-(2,6-difluorophenoxy)pyrimidin-4-yloxy]phenyl]-3-methoxyacrylate, methyl(E)-2-[2-[3-(pyrimidin-2-yloxy)phenoxy]phenyl]-3-methoxyacrylate, methyl(E)-2-[2-[3-(5-methylpyrimidin-2-yloxy)-phenoxy]phenyl]-3-methoxyacrylate, methyl(E)-2-[2-[3-(phenylsulphonyloxy)phenoxy]phenyl]-3-methoxyacrylate, methyl(E)-2-[2-[3-(4-nitrophenoxy)phenoxy]phenyl]-3-methoxyacrylate, methyl(E)-2-[2-phenoxyphenyl]-3-methoxyacrylate, methyl(E)-2-[2-(3,5-dimethylbenzoyl)pyrrol-1-yl]-3-methoxyacrylate, methyl(E)-2-[2-(3-methoxyphenoxy)phenyl]-3-methoxyacrylate, methyl(E)-2-[2-(2-phenylethen-1-yl)-phenyl]-3-methoxyacrylate, methyl(E)-2-[2-(3,5-dichlorophenoxy)pyridin-3-yl]-3-methoxyacrylate, methyl(E)-2-(2-(3-(1,1,2,2-tetrafluoroethoxy)phenoxy)phenyl)-3-methoxyacrylate, methyl(E)-2-(2-[3-α-hydroxybenzyl)phenoxy]phenyl)-3-methoxyacrylate, methyl(E)-2-(2-(4-phenoxypyridin-2-yloxy)phenyl)-3-methoxyacrylate, methyl(E)-2-[2-(3-n-propyloxyphenoxy)phenyl]-3-methoxyacrylate, methyl(E)-2-[2-(3-isopropyloxyphenoxy)phenyl]-3-methoxyacrylate, methyl(E)-2-[2-[3-(2-fluorophenoxy)phenoxy]phenyl]-3-methoxyacrylate, methyl(E)-2-[2-(3-ethoxyphenoxy)phenyl]-3-methoxyacrylate, methyl(E)-2-[2-(4-tert-butylpyridin-2-yloxy)phenyl]-3-methoxyacrylate; fenfuram, furcarbanil, cyclafluramid, furmecyclox, seedvax, metsulfovax, pyrocarbolid, oxycarboxin, shirlan, mebenil (mepronil), benodanil, flutolanil; benzimidazoles such as carbendazim, benomyl, furathiocarb, fuberidazole, thiophonatmethyl, thiabendazole or their salts; morpholine derivatives such as tridemorph, fenpropimorph, falimorph, dimethomorph, dodemorph; aldimorph, fenpropidine, and their arylsulphonates, such as, for example, p-toluenesulphonic acid and p-dodecylphenylsulphonic acid; benzothiazoles such as 2-mercaptobenzothiazole; benzamides such as 2,6-dichloro-N-(4-trifluoromethylbenzyl)-benzamide; formaldehyde and formaldehyde-releasing compounds such as benzyl alcohol mono(poly)-hemiformal; oxazolidine; hexa-hydro-5-triazines; N-methylolchloroacetamide; paraformaldehyde; nitropyrin; oxolinic acid; tecloftalam; tris-N-(cyclohexyldiazeneiumdioxy)-aluminium; N-(cyclohexyldiazeneiumdioxy)-tributyltin; N-octyl-isothiazolin-3-one; 4,5-trimethylene-isothiazolinone; 4,5-benzoisothiazolinone; N-methylolchloroacetamide; pyrethroids such as allethrin, alphamethrin, bioresmethrin, byfenthrin, cycloprothrin, cyfluthrin, decamethrin, cyhalothrin, cypermethrin, deltamethrin, α-cyano-3-phenyl-2-methylbenzyl-2,2-dimethyl-3-(2-chloro-2-trifluoro-methylvinyl)cyclopropane-carboxylate, fenpropathrin, fenfluthrin, fenvalerate, flucythrinate, flumethrin, fluvalinate, permethrin, resmethrin, and tralomethrin; nitroimines and nitromethylenes such as 1-[(6-chloro-3-pyridinyl)-methyl]-4,5-dihydro-N-nitro-1H-imidazol-2-amine (imidacloprid), N-[(6-chloro-3-pyridyl)methyl]-N²-cyano-N¹-methylacetamide (NI-25); quaternary ammonium compounds such as didecyldimethylammonium salts, benzyldimethyltetradecylammonium chloride, benzyldimethyldodecylammonium chloride, didecyldimethaylammonium chloride, and the like; phenol derivatives such as tribromophenol, tetrachlorophenol, 3-methyl-4-chlorophenol, 3,5-dimethyl-4-chlorophenol, phenoxyethanol, dichlorophene, o-phenylphenol, m-phenylphenol, p-phenylphenol, 2-benzyl-4-chlorophenol, and their alkali metal and alkaline earth metal salts; iodine derivatives such as diiodomethyl p-tolyl sulphone, 3-iodo-2-propinyl alcohol, 4-chloro-phenyl-3-iodopropargyl formal, 3-bromo-2,3-diiodo-2-propenyl ethylcarbamate, 2,3,3-triiodoallyl alcohol, 3-bromo-2,3-diiodo-2-propenyl alcohol, 3-iodo-2-propinyl n-butylcarbamate, 3-iodo-2-propinyl n-hexylcarbamate, 3-iodo-2-propinyl cyclohexyl-carbamate, 3-iodo-2-propinyl phenylcarbamate, and the like; microbicides having an activated halogen group such as chloroacetamide, bronopol, bronidox, tectamer, such as 2-bromo-2-nitro-1,3-propanediol, 2-bromo-4′-hydroxy-acetophenone, 2,2-dibromo-3-nitrile-propionamide, 1,2-dibromo-2,4-dicyanobutane, β-bromo-α-nitrostyrene, and the like; and the like; and combinations thereof. These are merely exemplary of the known and useful biocides, and the list could easily extend further.

Certain preferred biocides are oil-soluble, and can include quaternary ammonium compounds, including, for example, didecyldimethylammonium salt; azoles/triazoles such as N-alkylated tolytriazoles, metconazole, imidacloprid, hexaconazole, azaconazole, propiconazole, tebuconazole, cyproconazole, bromoconazole, and tridemorph tebuconazole; moldicides; HDO (available commercially by BASF); or mixtures thereof. Biocides such as tebuconazole are quite soluble in common organic solvents while others such as chlorothalonil possess only low solubility.

To apply the biocide to particulates, the biocide/organic composition can be combined, taking care that the biocide is dispersed and preferably solubilized in the organic composition. The biocide/organic composition can be prepared in a manner known, for example, by mixing the active compounds with the solvent or diluent, emulsifier, dispersant and/or binder or fixative, water repellant, and, if appropriate, dyes, pigments, and other processing auxiliaries. Then, the biocide/organic composition can be mixed with particulates, which can be suspended in a slurry, be wet, or be dry. The composition can be mixed to aid the wetting of and distribution of the biocide/organic composition to particulates. The composition may be heated, for example to about 40° C., and can also be beneficially allowed to sit for a period of time ranging from minutes to hours. The mixture can then be incorporated into a slurry or be dried or formulated into a stable concentrated slurry for shipping.

In an alternative embodiment, the biocide/organic composition can be applied as a spray or aerosol onto individual particles, such as particles suspended in a gas stream. The coated particulates are then treated to prevent coalescence by, for example, drying the oil to remove tackiness or coating the particle with other adjuvants such as anticoagulants, wettability agents, dispersibility agents, and the like. Such a product can be stored, shipped, and sold as a dry pre-mix.

In another embodiment, the particles can be wetted with a light organic material, which may or may not contain biocide, and the organic material can then be substantially removed by washing or drying, leaving a very thin layer of organic residue that may range from about 1 to about 30 nanometers thick, for example. Such a very thin layer can have negligible tackiness and negligible weight, but should protect the particulate from dissolution and discourage coagulation in the slurry.

Injectable Slurry—In a variation of the invention, the preservative composition may be a slurry that comprises: a liquid carrier; injectable solid particulates comprising one or more organic biocides, and one or more soluble metal salts or complexes, including the soluble iron treatments described in the prior art. The particulates in this variant of the invention are primarily carriers for the organic biocides.

In one embodiment of the invention, the metal-based particles (e.g., iron-based particles and/or copper-based particles) have a surface area (BET) of at least about 10 m²/gram, for example, at least about 40 m²/gram, at least about 75 m²/gram, or about 80 m²/gram. The particle size distribution of the particulates, in one embodiment, can be such that at least about 30% by weight of the particulates have an average diameter between about 0.07 microns and about 0.5 microns, or preferably at least about 50% by weight of the particulates have an average diameter between about 0.1 microns and about 0.4 microns.

In one preferred embodiment, the metal-based particles (e.g., iron-based particles and/or copper-based particles) comprise or consist essentially of any sparingly soluble substantially crystalline (or sparingly soluble amorphous) metal salts. In another embodiment, the substantially crystalline metal (e.g, iron and/or copper) composition in metal-based particulate and/or metal-based particulate material can further comprise one or more soluble substantially crystalline iron salts, where the soluble, substantially crystalline iron salt phase is stabilized against dissolution.

An exemplary preservative of the invention comprises sparingly soluble iron salt particles having an average particle diameter of less than about 500 nanometers, for example, less than about 250 nanometers, or less than about 200 nanometers. In a preferred embodiment, the average particle diameter is at least about 25 nanometers, for example, at least about 50 nanometers. In a most preferred embodiment, the sparingly soluble (and preferably substantially crystalline) iron-based particulates advantageously have a median particle size below about 0.6 microns, preferably between about 0.1 and about 0.4 microns. The particle size distribution of the particulates is typically such that less than about 1% by weight, preferably less than about 0.5% by weight, of the particulates have an average diameter greater than 1 micron. Preferably the particle size distribution of the particulates is such that less than about 1% by weight, preferably less than about 0.5% by weight, of the particulates have an average diameter greater than about 0.6 microns. In one embodiment, the particle size distribution of the particulates is such that at least about 30% by weight of the particulates have an average diameter between about 0.07 microns and about 0.5 microns. In a preferred embodiment, the particle size distribution of the particulates is such that at least about 50% by weight of the particulates have an average diameter between about 0.1 microns and about 0.4 microns.

In preferred embodiments of this invention, the slurry is substantially free of alkanolamines, e.g., the slurry comprises less than about 1% alkanolamines, preferably less than about 0.1% alkanolamines, or is completely free of alkanolamines.

In preferred embodiments of this invention, the slurry is substantially free of amines, e.g., the slurry comprises less than about 1% amines, preferably less than about 0.1% amines, or is completely free of amines, with the proviso that amines whose primary function is as an organic biocide are excluded from this.

In preferred embodiments of this invention, the slurry is substantially free of solvents, e.g., the slurry comprises less than about 1% organic solvents, preferably less than about 0.1% organic solvents, or is completely free of organic solvents.

The loading of the particulates in the slurry will depend on a variety of factors, including the desired metal (e.g., iron and/or copper) loading in the wood, the porosity of the wood, and the dryness of the wood. Calculating the amount of metal-based particulates and/or other particulates in the slurry is well within the skill of one of ordinary skill in the art. Generally, the desired metal (e.g, iron and/or copper) loading into wood is between 0.025 and about 0.5 pounds metal per cubic foot of wood.

In a preferred embodiment, the liquid carrier consists essentially of water and optionally one or more additives to aid particulate dispersion, to provide pH maintenance, to modify interfacial tension (surfactants), and/or to act as anticoagulants. In another embodiment, the carrier consists essentially of water; optionally one or more additives to aid particulate dispersion, to provide pH maintenance, to modify interfacial tension (surfactants), and/or to act as anticoagulants; and an emulsion of oil containing organic biocides dissolved and/or dispersed therein.

Advantageously, the pH of the liquid carrier is between about 7 and about 9, for example between about 7.5 to about 8.5. The pH can be adjusted with sodium hydroxide, potassium hydroxide, alkaline earth oxides, methoxides, or hydroxides; or less preferably ammonium hydroxide. The pH of the injectable slurry is typically between pH 6 and 11, preferably between 7 and 10, for example between 7.5 and about 9.5.

In one embodiment the slurry comprises between 50 and 800 ppm of one or more scale precipitation inhibitors, particularly organophosphonates. Alternately or additionally, the slurry may contain between about 50 and about 2000 ppm of one or more chelators. Both of these additives are meant to inhibit precipitation of salts such as calcium carbonate and the like, where the source of calcium may be from the water used to make up the slurry. The preferred inhibitors are hydroxyethylidene diphosphonic acid (HEDP), diethylenetriamine-pentamethylenephosphonic acid (DTPMP), and/or 2-phosphonobutane-1,2,4-tricarboxylic acid (PBTC). If the preservative is in a slurry concentrate, the slurry should comprise between 10 mmoles and 100 mmoles/L of HEDP, or between 30 mmoles and 170 mmoles/L of PBTC or DTPMP. Mixtures of inhibitors are preferred, as concentrates may have more inhibitor than can readily be solubilized therein. If the preservative is in a solid form, the preservative should comprise between about 0.1 to about 1 mole HEDP per kg of particulates, or between about 0.17 to about 2 mole PBTC and/or DTPMP per kg of particulates.

In one embodiment of the invention, a precipitate comprising metal-based (e.g., iron-based and/or copper-based) particles is prepared in the presence of a material that inhibits precipitation of at least one of calcium and magnesium. Alternatively, a material that inhibits precipitation of at least one of calcium and magnesium is added to a mixture comprising metal-based particles of the invention. In one embodiment, the precipitation inhibitor is a chelator comprising having at least one ethylene diamine compound, such as an ethylenediamine-tetramethylene compound or ethylenediaminetetraacetate compound. An acid, such as a phosphonic or acetic acid, of the ethylenediamine compound may be used. Salts of the ethylenediamine compound may also be used. In one embodiment, the precipitation inhibitor comprises at least one and preferably at least two phosphonic groups. The precipitation inhibitor may comprise a phosphonic acid or salt of a phosphonic acid. The precipitation inhibitor may comprise at least one of a hydroxyethylidene diphosphonic acid and an aceto diphosphonic acid. A suitable phosphonate may be synthesized from phosphorous acid by reaction with formaldehyde and either ammonia or amines. A wood preservative of the invention may include at least one of a ethylenediamine tetra methylenephosphonic acid, a hexamethylenediamine tetra methylenephosphonic acid, a diethylenetriamine penta methylenephosphonic acid, and a 1-hydroxyethane diphosphonic acid.

If the wood preservative treatment will comprise organic biocides, these biocides may be partially or fully coated onto the sparingly soluble (and preferably substantially crystalline) metal-based particulates. Preferred preservative materials inhibit organisms that may be resistant to metal-based preservatives. Moldicides useful in wood or wood product preservation are also preferred organic biocides. Alternatively or additionally, these biocides may be partially or fully coated onto the available surface area of a particulate carrier. If the biocides are to be added to the slurries as an emulsion, the organic biocides are beneficially kept separate from the concentrated slurry or paste is of this invention until the injectable slurry is formulated.

If a dispersing agent is present in the preservative composition according to the invention, the ratio of the weight of metal present in the metal-based particles to the weight of dispersing agent present in the suspension may be at least about 1 to 1, for example at least about 5 to 1, alternately at least about 10 to 1, at least about 15 to 1, at least about 20 to 1, or at least about 30 to 1.

In one embodiment, the dispersing agent is substantially free of phosphate ion. For example, the dispersing agent may be substantially free of trisodium phosphate. The dispersing agent may be substantially free of silicates, sodium carbonate and ammonia. By substantially free of one or more particular dispersing agents, it is meant that the weight percent of the one or more dispersing agent relatives to the iron-based particles is less than 3%. In one embodiment, the weight percent of the one or more particular dispersing agents relative to the iron-based particles is less than about 2%, such as less than about 1%, for example, less than about 0.5%. In one embodiment, the dispersing agent is free of at least one of phosphate ion, trisodium phosphate, silicates, sodium carbonate, and ammonia.

Dispersing agents aid particulate dispersion and to prevent aggregation of particulates. Sub-micron sized particulates have a tendency to form much larger aggregates. Aggregates as used herein are physical combinations of a plurality of similarly-sized particles, often brought together by VanDerWaal's forces or electrostatic forces. By similarly-sized we mean the particles forming the aggregate have diameters that are generally within a factor of five of each other. Such aggregates are not desired in the compositions of this invention. If aggregates are allowed to form they often can age into a stable aggregate that can not be readily broken up by mechanical agitation, for example by vigorous stirring of a slurry. Such aggregates may grow to a size where the aggregates are not readily injectable, or may be of a size to make the aggregates visible, therefore adding undesired color. In preferred embodiments of the invention at least about 30%, preferably at least about 60%, more preferably at least about 90%, by weight of the substantially crystalline iron-based particulates in a slurry are dispersed, i.e., do not significantly aggregate. To prevent particulates from agglomerating, the concentrated slurry or paste may comprise cationic, anionic, and/or non-ionic surfactants; emulsifiers such as gelatine, casein, gum arabic, lysalbinic acid, and starch; and/or polymers, such as polyvinyl alcohols, polyvinyl pyrrolidones, polyalkylene glycols and polyacrylates, for example, in quantities of about 0.1% to about 20% by weight, based on the weight of the particulates.

The slurry formulations mentioned can be prepared in a manner known by one skilled in the art, for example, by mixing the active compounds with the liquid carrier, and including emulsifier, dispersants and/or binders or fixative, and other processing auxiliaries. Particulates can be provided in a concentrated slurry, in a very concentrated paste, as dry particulates, as coated dry particulates, as part of a dry pre-mix, or any combination thereof.

The moisture content of metal-based particles of the invention may be reduced, such as by drying. A dispersing agent may be used to inhibit irreversible agglomeration of reduced moisture particles of the invention. The reduced moisture particles may be diluted, such as by hydration with water or combination with another liquid. Generally, dilution may be with water, beneficially fresh water.

Another aspect of the invention relates to an agglomeration comprising a plurality of metal-based particles and, optionally, a dispersing agent. The agglomeration may also include one or more materials additional to the metal-based particles that also provide a wood or wood product preservative function. The agglomeration may have a liquid content (excluding any additional preservative material that may be present) of less than about 75% by weight, for example less than about 50%, alternately less than about 25%, less than about 15%, or less than about 5% by weight. The liquid may be water. The agglomeration may be diluted and/or dispersed with mixing or agitation, such as mechanically or ultrasonically.

Dry Particulates and Dry Mix For Slurry—The particulates are preferably sold as a dry component. The dry component can be simply the metal-based particulates, which may be coated or uncoated. If coated, the coating can be inorganic, organic, or both. The particulates advantageously comprise one or more additives such as are described as being present in the slurry, including, for example, particulates having organic biocides thereon, antioxidants, surfactants, disbursing agents, other biocidal salts and compounds, chelators, corrosion inhibitors, pH modifiers and/or buffers, and the like. The additives can be coated onto the sparingly soluble iron-based particulates and/or can be formed from separate particulates.

The dry-mix material advantageously has, in addition to dry particulates discussed above, all necessary components in a single mix, and each component is present in a range that is useful when the dry mix is formed into an injectable slurry. The mixture may optionally but preferably incorporate a granulating material, which is a material that when wet holds a plurality of particulates together in the form of a granule, but that dissolves and releases the individual particulates on being admixed with the liquid carrier. Granules are preferred over sub-micron-sized particulates because of dust problems and also the ease of measuring and handling a granular mixture. Granulating agents can be simple soluble salts, that are sprayed onto or otherwise is mixed with the particulate material. Several additives to a slurry can be also used as granulating agents.

The metal-based material may comprise additional material providing a wood preservative and/or biocide function. For example, in one embodiment the material comprises a plurality of metal-based particles and a co-biocide. Exemplary co-biocides may include, for example, one or more of a sparingly soluble copper salt (e.g., according to co-pending U.S. patent application Ser. No. 10/868,967), a triazole compound, a quartemary amine, and a nitroso-amine.

Method Of Preserving Wood

Another aspect of the invention relates to wood or a wood product comprising metal-based particles (e.g., iron-based particles) and, optionally, one or more additional materials having a preservative function, injected into a piece of wood. An exemplary piece of wood comprising iron-based particles has a volume of at least about 6 cm³, for example, at least about 100 cm³, for such as at least about 1,000 cm³.

The material of this invention is useful for wood, and also for wood composites. Preferred wood composites have the preservative of this invention either mixed with the wood particles before bonding, or preferably injected into the wood particulates and dried prior to bonding. Exemplary wood products include oriented strand board (OSB), particle board (PB), medium density fiberboard (MDF), plywood, laminated veneer lumber (LVL), laminated strand lumber (LSL), hardboard and the like.

In one embodiment, the wood or wood product has a surface, a thickness, a width, and a length. Preferably, the wood or wood product comprises a homogenous distribution of iron-based particles of the invention. In one embodiment, a volume number density of the iron-based particles about 5 cm from the surface, and preferably throughout the interior of the wood or wood product, is at least about 50%, for example at least about 60%, alternately at least about 70% or at least about 75%, of the volume number density of the iron-based particles about 1 cm from the surface.

Wood or wood products comprising metal-based (e.g., iron-based) particles in accordance with the present invention may be prepared by subjecting the wood to vacuum and/or pressure in the presence of a flowable material comprising the metal-based (e.g., iron-based) particles. A pre-injection of carbon dioxide followed by vacuum and then injection of the slurry is one method of injecting the slurry into wood. Injection of particles into the wood or wood product from a flowable material comprising the particles may require longer pressure treatments than would be required for liquids free of such particles. Pressures of, for example, at least about 75 psi, at least about 100 psi, or at least about 150 psi may be used. Exemplary flowable materials include liquids comprising iron-based particles, emulsions comprising metal-based (e.g., iron-based) particles, and slurries comprising metal-based (e.g., iron-based) particles.

What is claimed is:

1. A wood preservative composition comprising injectable particles of sparingly soluble iron salts, wherein the particle size distribution of the sparingly soluble iron salts is such that the d₉₈ is about 0.7 microns or less, and the d_{99.5} is about 1.5 microns or less.

2. The wood preservative composition of claim 1, further comprising a soluble copper complex.

3. The wood preservative composition of claim 2, wherein the copper complex is a copper-amine complex, an ammoniacal copper, or copper monoethanolamine carbonate.

4. The wood preservative composition of claim 1, further comprising injectable particles of sparingly soluble copper salts.

5. The wood preservative composition of claim 4, wherein the sparingly soluble copper salt comprises copper hydroxide, basic copper carbonate, basic copper sulfate, basic copper chloride, basic copper phosphate, basic copper borate, or basic copper phosphosulfate.

6. The wood preservative composition of claim 1, further comprising injectable particles of sparingly soluble zinc salts.

7. The wood preservative composition of claim 6, wherein the zinc salt is zinc oxide, basic zinc carbonate, zinc hydroxide, or zinc phosphate.

8. The wood preservative composition of claim 1, further comprising an injectable suspension of a milled, solid, substantially insoluble organic biocide.

9. The wood preservative composition of claim 8, wherein the solid, substantially insoluble organic biocide comprises a triazole, a quaternary ammonium compound, or a carbamide.

10. The wood preservative composition of claim 1, wherein the particles comprise an iron oxide.

11. A wood preservative composition comprising iron oxide particles, wherein the particle size distribution of the iron oxide particles is such that the d₉₈ is about 0.7 microns or less, and the d_{99.5} is about 1.5 microns or less.

12. The wood preservative of claim 11, wherein the particle size distribution of the iron oxide particles is such that d₅₀ is between about 25 nanometers and about 500 nanometers.

13. The wood preservative of claim 11, wherein the particle size distribution of the iron oxide particles is such that d₅₀ is between about 50 nanometers and about 250 nanometers.

14. The wood preservative of claim 11, wherein the iron oxide particles are wet milled with a milling media comprising beads having a diameter between about 0.1 mm and about 0.8 mm, and having a density greater than 3 g/cc.

15. The wood preservative of claim 11, wherein the injectable particles comprise a substantially insoluble organic biocide disposed on the surface thereof.

16. The wood preservative of claim 15, wherein the organic biocide further comprises a surface-active agent.

17. The wood preservative of claim 11, further comprising a scale precipitation inhibitor.

18. The wood preservative of claim 17, wherein the scale precipitation inhibitor is an organophosphonate.

19. A wood preservative composition comprising:
a liquid carrier; and
injectable solid iron oxide particlulates coated with an organic biocide.

20. The wood preservative of claim 19, further comprising injectable particles of sparingly soluble copper salts.

21. The wood preservative of claim 19, wherein the liquid carrier is substantially free of amines.

22. A method of preserving wood comprising:
contacting wood with a wood preservative composition comprising an aqueous solution of injectable particles of sparingly soluble copper salts and injectable particles of sparingly soluble iron salts.

23. The method of claim 22, wherein the sparingly soluble iron salts comprise iron oxide.

24. The method of claim 22, wherein the composition further comprises at least one injectable solid organic compound.
